(19) United States
(12) Patent Application Publication
(10) Pub. No.: US 2024/0418254 A1
(43) Pub. Date: Dec. 19, 2024

(54) STAMPED GEARTRAIN COVER

(71) Applicant: Schaeffler Technologies AG & Co. KG, Herzogenaurach (DE)

(72) Inventors: David Burky, Massillon, OH (US); Christopher Shamie, Wooster, OH (US)

(73) Assignee: Schaeffler Technologies AG & Co. KG, Herzogenaurach (DE)

(21) Appl. No.: 18/543,435

(22) Filed: Dec. 18, 2023

Related U.S. Application Data
(60) Provisional application No. 63/521,203, filed on Jun. 15, 2023.

(51) Int. Cl. F16H 57/031; F16H 1/06; F16H 57/021; F16H 57/029

(52) U.S. Cl. CPC F16H 57/031; F16H 1/06; F16H 57/021; F16H 57/029; F16H 2057/02052

(57) ABSTRACT

A stamped geartrain cover includes a radially outer flange portion for fixing to a geartrain housing, a dished portion extending axially from the radially outer flange portion, and a stepped protrusion arranged for receiving a first bearing. The stepped protrusion may include a first cylindrical protrusion extending from the dished portion and an annular ring extending radially inward from the first cylindrical protrusion. The stepped protrusion may also include a second cylindrical protrusion, coaxial with the first cylindrical protrusion, extending from the annular ring. The second cylindrical protrusion may include an opening for receiving an axle shaft. The second cylindrical protrusion may be arranged for receiving an axle shaft seal. The first cylindrical protrusion may extend from the annular ring in a first axial direction and the second cylindrical protrusion may extend from the annular ring in a second axial direction, opposite the first axial direction.

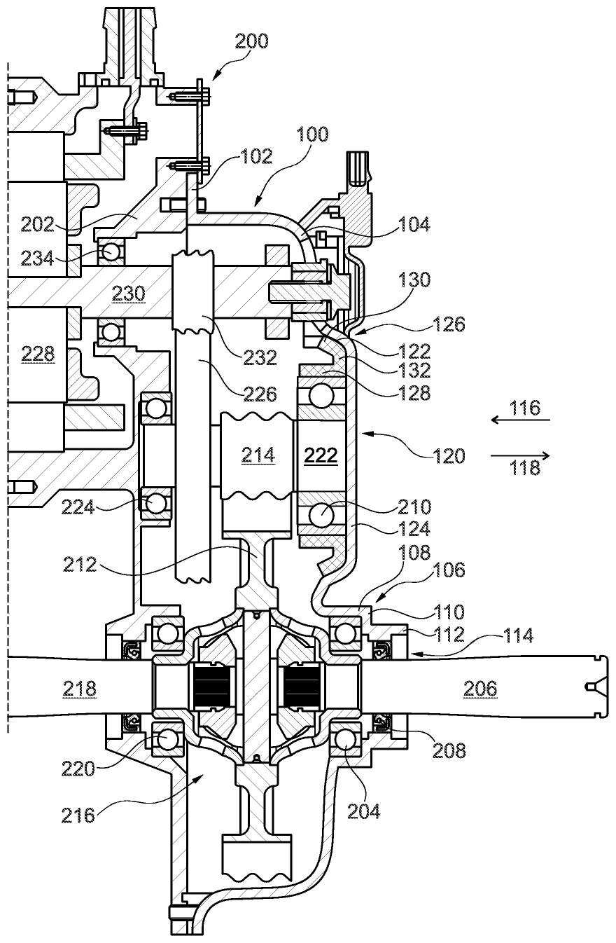

### CROSS-REFERENCE TO RELATED APPLICATIONS

This application claims the benefit of U.S. Provisional Patent Application No. 63/521,203, filed Jun. 15, 2023, the disclosure of which is incorporated in its entirety by reference herein.

### TECHNICAL FIELD

The present disclosure relates generally to a geartrain cover, and more specifically to a stamped geartrain cover.

### BACKGROUND

Gearbox covers with formed bearing cavities are known. One example is shown and described in United States Patent Application Publication No. 2023/0126628 titled BOLT THROUGH INTERMEDIATE SHAFT OF PARALLEL AXIS GEARBOX to Labelle.

### SUMMARY

Example aspects broadly comprise a stamped geartrain cover including a radially outer flange portion for fixing to a geartrain housing, a dished portion extending axially from the radially outer flange portion, and a stepped protrusion arranged for receiving a first bearing. In some example embodiments, the stepped protrusion includes a first cylindrical protrusion extending from the dished portion and an annular ring extending radially inward from the first cylindrical protrusion. In some example embodiments, the stepped protrusion also includes a second cylindrical protrusion, coaxial with the first cylindrical protrusion, extending from the annular ring. The second cylindrical protrusion includes an opening for receiving an axle shaft. In an example embodiment, the second cylindrical protrusion is arranged for receiving an axle shaft seal. In an example embodiment, the first cylindrical protrusion extends from the annular ring in a first axial direction and the second cylindrical protrusion extends from the annular ring in a second axial direction, opposite the first axial direction.

In some example embodiments, the stamped geartrain cover also includes a tapered protrusion offset from the stepped protrusion. In an example embodiment, the tapered protrusion includes a tapered ring and an annular disc. In some example embodiments, the stamped geartrain cover also includes a separate bearing support fixed in the tapered protrusion. In an example embodiment, the tapered protrusion and the separate bearing support includes respective tapered surfaces contacting one another. In an example embodiment, the separate bearing support is fixed to the tapered protrusion. In an example embodiment, the separate bearing support includes a third cylindrical protrusion arranged for receiving a second bearing. In an example embodiment, the separate bearing support comprises a “J” shaped cross-section.

Other example aspects broadly comprise a geartrain for a vehicle including a geartrain housin, the stamped geartrain cover fixed to the geartrain housing at the radially outer flange portion, and a first gear. In some example embodiments, the geartrain also includes a second gear in meshing engagement with the first gear. In some example embodiments, the geartrain also includes a first bearing disposed in the stepped protrusion and an axle shaft supported by the first bearing. In some example embodiments, the geartrain also includes a second bearing, the stamped geartrain cover also includes a tapered protrusion offset from the stepped protrusion and a separate bearing support fixed in the tapered protrusion, and the second bearing is disposed in the separate bearing support. In some example embodiments, the geartrain also includes a gear shaft supported by the second bearing. In some example embodiments, the first gear is coaxial with the axle shaft and the second gear is coaxial with the gear shaft. In an example embodiment, the geartrain also includes an axle shaft seal disposed in the stepped protrusion for sealing the axle shaft to the stamped geartrain cover.

### BRIEF DESCRIPTION OF THE DRAWINGS

The single FIGURE illustrates a partial cross-sectional view of a geartrain including a stamped geartrain cover according to an example aspect of the present disclosure.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

The following description is made with reference to the single FIGURE. The single FIGURE illustrates a partial cross-sectional view of geartrain 200 including stamped geartrain cover 100. Stamped geartrain cover 100 includes radially outer flange portion 102 for fixing to a geartrain housing (e.g., geartrain housing 202 as described below), dished portion 104 extending axially from the radially outer flange portion and stepped protrusion 106 arranged for receiving a bearing (e.g., bearing 204 as described below). Stepped protrusion 106 includes cylindrical protrusion 108 extending from the dished portion and annular ring 110 extending radially inward from cylindrical protrusion 108. Annular ring 110 forms an axial support for bearing 204, for example.

Stepped protrusion 106 also includes cylindrical protrusion 112, coaxial with cylindrical protrusion 108, extending from the annular ring. Cylindrical protrusion 112 includes opening 114 for receiving an axle shaft (e.g., axle shaft 206 as described below). Cylindrical protrusion 112 is arranged for receiving an axle shaft seal (e.g., axle shaft seal 208 as described below). As shown in the FIGURE, cylindrical protrusion 108 extends from the annular ring in axial direction 116 and cylindrical protrusion 112 extends from the annular ring in axial direction 118, opposite axial direction 116.

Stamped geartrain cover 100 includes tapered protrusion 120 offset from the stepped protrusion. The tapered protrusion includes tapered ring 122 and annular disc 124. Stamped geartrain cover 100 includes separate bearing support 126 fixed in the tapered protrusion. By separate, we mean that the bearing support 126 is a separate component formed from a separate piece of material as opposed to the previously discussed features of the stamped geartrain cover (e.g., flange portion, dished portion, stepped protrusion, tapered protrusion) which are all formed from a single piece of material by cold forming (e.g., stamping). Tapered protrusion 120 and bearing support 126 comprise respective tapered surfaces contacting one another. In other words, the bearing support rests against the tapered ring of the tapered protrusion.

The separate bearing support is fixed to the tapered protrusion (e.g., by welding, adhesives, brazing, press-fitting, bolting, riveting, or another fixing method). Bearing support 126 includes cylindrical protrusion 128 arranged for receiving a bearing (e.g., bearing 210 as described below). As can be seen in the cross-sectional FIGURE, the separate bearing support has a “J” shaped cross-section with angled portion 130 connected to cylindrical protrusion 128 by annular ring 132.

Geartrain 200 is for a vehicle. That is, geartrain 200 may be an electric axle for a vehicle, for example. Geartrain 200 includes geartrain housing 202, stamped geartrain cover 100 fixed to the geartrain housing at the radially outer flange portion, and gear 212. As shown in the FIGURE, gear 212 is disposed in the dished portion such that an entirety of gear 212 is disposed between outer flange portion 102 and a base of the dished portion. Cover 100 may be positioned by dowels (not shown) installed in housing 202 extending through apertures in cover 100, for example. Cover 100 may be fixed to the housing by bolts extending through separate apertures in the cover, for example. Geartrain 200 also includes gear 214 in meshing engagement with gear 212. That is, gear teeth of gears 212 and 214 are aligned such that rotation of one gear rotates the other gear in a known manner. As shown in the FIGURE, gear 214 is disposed in the dished portion and rotation axes of the gears are radially offset so that the two gears are NOT coaxial.

Geartrain 200 also includes bearing 204 disposed in the stepped protrusion and axle shaft 206 supported by bearing 204. Bearing 204 may be press-fit in cylindrical protrusion 108 or press-fit onto axle shaft 206, for example. It should be noted that axle shaft 206 extends through cover 100 to engage differential assembly 216 and gear 212 is fixed to the differential assembly. Therefore, bearing 204 also supports gear 212 through the axle shaft. Geartrain 200 also includes axle shaft 218 supported by bearing 220 installed in housing 202. Axle shafts 206 and 218 extend axially outward from the housing and the cover towards vehicle wheels (not shown) to provide propulsion for the vehicle. Gear 212 may be referred to as a final drive gear, for example.

Geartrain 200 also includes bearing 210 disposed in separate bearing support 126 and gear shaft 222 supported by bearing 210. As with bearing 204 discussed above, bearing 210 may be press-fit into bearing support 126 or press-fit onto gear shaft 222, for example. Gear 212 is coaxial with axle shaft 206 and gear 214 is coaxial with the gear shaft. As discussed above, gear 212 is supported by axle shaft 206. Similarly, gear 214 is supported by gear shaft 222. Gears 212 and 214 provide a final drive ratio for geartrain 200. Geartrain 200 also includes axle shaft seal 208 disposed in the stepped protrusion for sealing the axle shaft to the stamped geartrain cover.

Geartrain 200 may also include bearing 224 disposed in housing 202 for supporting gear shaft 222 and gear 226 disposed on gear shaft 222. Gears 214 and 226 are fixed to gear shaft 222 so that the rotate together. Geartrain 200 may include electric motor 228 with motor shaft 230 and gear 232, fixed to motor shaft 230 and in meshing engagement with gear 226. Bearing 234, disposed in housing 202, supports motor shaft 230.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Stamped geartrain cover

102 Radially outer flange portion

104 Dished portion

106 Stepped protrusion

108 Cylindrical protrusion (first)

110 Annular ring

112 Cylindrical protrusion (second)

114 Opening (cylindrical protrusion 112)

116 Axial direction (first)

118 Axial direction (second)

120 Tapered protrusion

122 Tapered ring

124 Annular disc

126 Bearing support

128 Cylindrical protrusion (third)

130 Angled portion (bearing support)

132 Annular ring (bearing support)

200 Geartrain

202 Geartrain housing

204 Bearing (first)

206 Axle shaft

208 Axle shaft seal

210 Bearing (second)

212 Gear (first)

214 Gear (second)

216 Differential assembly

218 Axle shaft

220 Bearing

222 Gear shaft

224 Bearing

226 Gear

228 Electric motor

230 Motor shaft

232 Gear

234 Bearing

What is claimed is:

1. A stamped geartrain cover, comprising:
a radially outer flange portion for fixing to a geartrain housing;
a dished portion extending axially from the radially outer flange portion; and
a stepped protrusion arranged for receiving a first bearing.

2. The stamped geartrain cover of claim 1 wherein the stepped protrusion comprises:
a first cylindrical protrusion extending from the dished portion; and
an annular ring extending radially inward from the first cylindrical protrusion.

3. The stamped geartrain cover of claim 2 wherein the stepped protrusion further comprises a second cylindrical protrusion, coaxial with the first cylindrical protrusion, extending from the annular ring, the second cylindrical protrusion comprising an opening for receiving an axle shaft.

4. The stamped geartrain cover of claim 3 wherein the second cylindrical protrusion is arranged for receiving an axle shaft seal.

5. The stamped geartrain cover of claim 3 wherein:
the first cylindrical protrusion extends from the annular ring in a first axial direction; and
the second cylindrical protrusion extends from the annular ring in a second axial direction, opposite the first axial direction.

6. The stamped geartrain cover of claim 1 further comprising a tapered protrusion offset from the stepped protrusion.

7. The stamped geartrain cover of claim 6 wherein the tapered protrusion comprises:
a tapered ring; and
an annular disc.

8. The stamped geartrain cover of claim 6 further comprising a separate bearing support fixed in the tapered protrusion.

9. The stamped geartrain cover of claim 8 wherein the tapered protrusion and the separate bearing support comprise respective tapered surfaces contacting one another.

10. The stamped geartrain cover of claim 8 wherein the separate bearing support is fixed to the tapered protrusion.

11. The stamped geartrain cover of claim 8 wherein the separate bearing support comprises a third cylindrical protrusion arranged for receiving a second bearing.

12. The stamped geartrain cover of claim 8 wherein the separate bearing support comprises a “J” shaped cross-section.

13. A geartrain for a vehicle comprising:
a geartrain housing;
the stamped geartrain cover of claim 1 fixed to the geartrain housing at the radially outer flange portion; and
a first gear.

14. The geartrain of claim 13 further comprising a second gear in meshing engagement with the first gear.

15. The geartrain of claim 14 further comprising:
a first bearing disposed in the stepped protrusion; and
an axle shaft supported by the first bearing.

16. The geartrain of claim 15 further comprising a second bearing, wherein:
the stamped geartrain cover further comprises:
a tapered protrusion offset from the stepped protrusion; and
a separate bearing support fixed in the tapered protrusion; and
the second bearing is disposed in the separate bearing support.

17. The geartrain of claim 16 further comprising a gear shaft supported by the second bearing.

18. The geartrain of claim 17 wherein the first gear is coaxial with the axle shaft and the second gear is coaxial with the gear shaft.

19. The geartrain of claim 18 further comprising an axle shaft seal disposed in the stepped protrusion for sealing the axle shaft to the stamped geartrain cover.
